(19) United States
(12) Patent Application Publication
(10) Pub. No.: US 2024/0361821 A1
(43) Pub. Date: Oct. 31, 2024

(54) ELECTRONIC DEVICE POWER STATE CONTROLS

(71) Applicant: Hewlett-Packard Development Company, L.P., Spring, TX (US)

(72) Inventors: Huai-Yung Yen, Taipei (TW); Isaac Lagnado, Spring, TX (US); Chih-Hung Chien, Taipei (TW); Chien-Pai Lai, Taipei (TW); Hsiao-Chun Su, Taipei (TW)

(73) Assignee: Hewlett-Packard Development Company, L.P., Spring, TX (US)

(21) Appl. No.: 18/553,777

(22) PCT Filed: Apr. 30, 2021
(86) PCT No.: PCT/US2021/030031

§ 371 Date: Oct. 3, 2023

(51) Int. Cl. G06F 1/3215; G06F 1/3231; G06F 1/3287; H04M 1/72457

(52) U.S. Cl. CPC G06F 1/3215; G06F 1/3231; G06F 1/3287; H04M 1/72457

(57) ABSTRACT

An electronic device may include a first wireless transceiver, a second wireless transceiver, and a processor. The processor may establish a first wireless communication with an external device via the first wireless transceiver. Further, processor may monitor a distance between the electronic device and the external device via the first wireless transceiver. In response to a determination that the monitored distance crosses a first threshold, the processor may establish a second wireless communication with the external device via the second wireless transceiver and monitor the distance between the electronic device and the external device via the second wireless transceiver. Furthermore, the processor may control the electronic device to operate in a first power state or a second power state based on the monitored distance via the first wireless transceiver or the second wireless transceiver.

### BACKGROUND

Portable electronic devices, such as laptop computers, have become popular because of lightweight and smaller size compared with desktop computers. Such electronic devices may use batteries to supply power to various components within the electronic devices. Battery life and power consumption may be the factors to consider as the electronic devices get smaller in size and significantly powerful in electronic capabilities, without sacrificing responsiveness of the electronic devices during wake up. For example, the battery life of an electronic device may depend on the power consumption of the electronic device, which in turn may depend on a number of components that are powered. Some example specifications may define a number of power states (e.g., a sleep state, standby state, hibernation state, or the like) for the electronic device to reduce the power consumption and enhance the battery life.

### BRIEF DESCRIPTION OF THE DRAWINGS

Examples are described in the following detailed description and in reference to the drawings, in which:

FIG. 1 is a block diagram of an example electronic device, depicting a processor to operate the electronic device in a first power state or a second power state based on a monitored distance;

FIG. 2 is a block diagram of an example electronic device, depicting a processor to return the electronic device to a working state from a power saving mode based on a user proximity to the electronic device;

FIG. 3A is a block diagram of an example electronic device including a non-transitory machine-readable storage medium, storing instructions to control the electronic device to operate in a power state based on a user proximity to the electronic device;

FIG. 3B is a block diagram of the example electronic device of FIG. 3A including the non-transitory machine-readable storage medium, storing instructions to perform additional features;

FIG. 4 is a schematic representation of an example electronic device, depicting a processor to return the electronic device to a working state from a power saving mode;

FIG. 5A is a schematic diagram, illustrating an example monitored distance and a corresponding operating condition of the electronic device of FIG. 4; and

FIG. 5B is a schematic diagram, depicting an example operation to return the electronic device of FIG. 4 to the working state from the power saving mode based on the monitored distance.

### DETAILED DESCRIPTION

Electronic devices may include a battery that allows the electronic devices to operate without being connected to an external power source. In order to conserve power and extend the length of time that a battery can last without recharging, some electronic devices can go into various power saving modes (i.e., power states) when there has been no user activity for a period of time. In such examples, the electronic devices may be integrated with hardware and/or software functions that allow automatic transition from an active or normal operational mode in which the electronic devices are functional and consume rated power, to a power saving mode in which the electronic devices consume reduced power relative to the active mode.

Power saving modes can be achieved by selectively controlling supply of power to various circuitries within an electronic device to reduce the power consumption of the electronic device. Depending on time periods in which the electronic device is idle, the electronic device (or portions thereof) may be placed in one of the various power saving modes. Example power saving modes may include a standby mode, sleep mode, hibernate mode, or the like. These power saving modes may save power at different levels by disabling different sets of peripherals or circuitries, with the standby mode consuming the maximum power and then decreasing in power consumption through the sleep mode and the hibernate mode, for example. The electronic device can go into a power saving mode by, for instance, turning off a display, turning off a hard disk, entering a system standby, entering system sleep, entering a system hibernation, or the like.

Some electronic devices may implement the standby modes such as a connected standby and a modern standby, to reduce the power consumption. The term “connected standby” may be an operating mode for an operating system (e.g., Windows®) in which the electronic device can remain in a low-powered, idle condition but can still be transitioned to a normal operational state without a significant delay. In the connected standby mode, the background activities such as fetching new mails may be still working in order to immediately resume the electronic device without the significant delay. The term “modern standby” may switch the electronic device between the connected standby and the disconnected standby to save the power consumption from the connected standby which keeps connecting to the Internet.

However, such power saving modes may consume significant power to operate background activities when the user is far away from the electronic device and not expected to use the electronic device anytime soon. For example, although the electronic device is in the modern standby or the connected standby, the electronic device may still run out of battery, as the electronic device may be connected to the Internet. The electronic device may keep triggering itself to connect to the Internet irrespective of a user proximity to the electronic device. When the electronic device keeps triggering itself to connect to the Internet, the power consumption of the electronic device may be increased and thereby affecting the battery life.

Additionally, when the electronic device is operating in the power saving mode, a user may have to perform an action in order to wake up the electronic device. For example, depending on which power mode the electronic device is currently operating in, a user may have to wake up the electronic device by pressing a key on a keyboard, tapping a touch pad, pressing a mouse button, or pressing a power button, which may affect the user experience.

Examples described herein may enable an electronic device to track a location of a user via different wireless technologies and control a power state of the electronic device based on the location of the user. In an example, the electronic device may include a first wireless transceiver, a second wireless transceiver, a sensor, and a processor.

During operation, the processor may establish a first wireless communication with an external device via the first wireless transceiver. Further, the processor may monitor a distance between the electronic device and the external device via the first wireless transceiver. In response to a determination that the monitored distance is less than a first threshold, the processor may establish a second wireless communication with the external device via the second wireless transceiver. The second wireless communication may have a property (e.g., a distance detection range, a power consumption, a distance detection accuracy, or the like) different from the first wireless communication.

Further, the processor may monitor the distance between the electronic device and the external device via the second wireless transceiver. Furthermore, the processor may control the electronic device to operate in a first power state when the monitored distance is greater than or equal to the first threshold, and to operate in a second power state when the monitored distance is less than the first threshold. Thus, examples described herein may enable the electronic device to connect to the Internet and operate background activities based on the user proximity to the electronic device, thereby enhancing the power consumption of the electronic device.

In another example, when the monitored distance via the second wireless transceiver is less than a second threshold, the processor may activate the sensor (e.g., a time-of-flight (ToF) camera) to determine whether a user is present at the electronic device. When the user is present at the electronic device, the processor may return the electronic device to a working state (e.g., unlocking an operating system) from a power saving state. Thus, examples described herein can unlock the operating system automatically via the paired external device before the user starts to use the electronic device.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

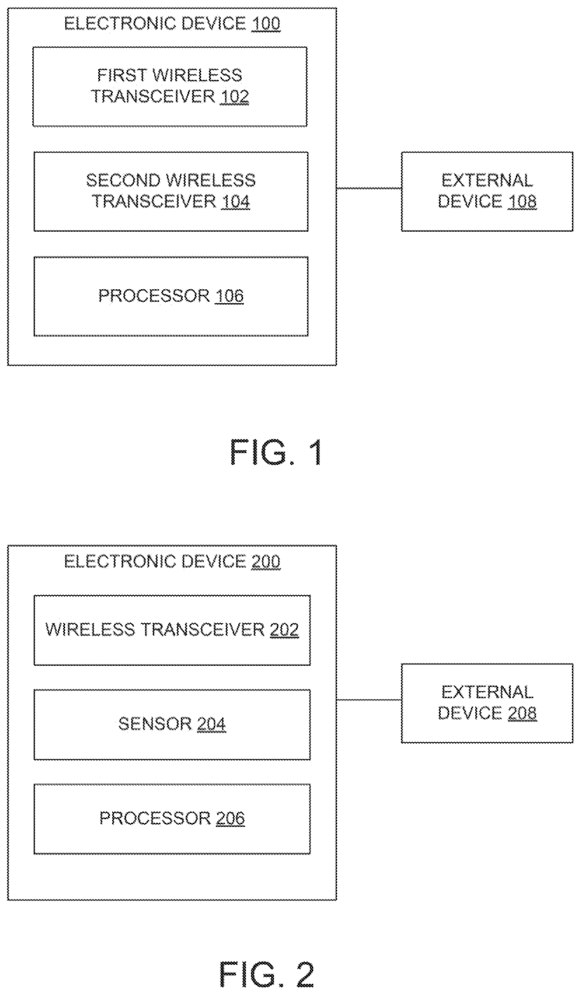

Turning now to the figures, FIG. 1 is a block diagram of an example electronic device 100, depicting a processor 106 to operate electronic device 100 in a first power state or a second power state based on a monitored distance. Example electronic device 100 may include a notebook computer, a tablet computer, a gaming laptop, a convertible device, or any other computing device that can operate in multiple power states. Example convertible device may refer to a device that can be “converted” from a laptop mode to a tablet mode. In the tablet mode, a display housing may be closed with a display panel facing up and viewable, i.e., the display housing may be substantially parallel to and adjacent to a base housing.

For example, an advanced configuration and power interface (ACPI) standard may define power states such as S0 mode, S1 mode (Standby state), S2 mode and S3 mode (Suspend to RAM), S4 mode (Hibernate mode), and S5 mode, where S0 mode is a working/active mode, S1 mode to S4 mode are several power saving modes, and S5 mode is a shutdown mode. In other examples, power states may also include a modern standby, a connected standby, or the like.

As shown in FIG. 1, electronic device 100 may include a first wireless transceiver 102, a second wireless transceiver 104, and processor 106 connected to first wireless transceiver 102 and second wireless transceiver 104. The term “wireless transceiver” may refer to a device or circuit that is able to both transmit and receive the radio frequency signals through a transmission medium. The wireless transceiver may exchange data communications using a wireless connection such as a Bluetooth communication, an Ultra-wideband (UWB) communication, a Near-Field Communication (NFC), a Zigbee communication, an Infrared communication, or the like. In an example, first wireless transceiver 102 and second wireless transceiver 104 may be a Bluetooth transceiver and a UWB transceiver, respectively, to exchange wireless communications in accordance with a corresponding one of a Bluetooth communication protocol and a UWB communication protocol.

Further, the term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. A processor may, for example, include single or multiple cores on a chip, multiple cores across multiple chips, multiple cores across multiple devices, or suitable combinations thereof. A processor may be functional to fetch, decode, and execute instructions as described herein.

During operation, processor 106 may establish a first wireless communication with an external device 108 via first wireless transceiver 102. For example, external device 108 may be a smartphone, a wearable device (e.g., a smart watch), a personal digital assistant, or any other portable electronic equipment that can wirelessly connect to electronic device 100. Further, processor 106 may monitor a distance between electronic device 100 and external device 108 via first wireless transceiver 102. Furthermore, processor 106 may determine whether the monitored distance crosses a first threshold. In response to a determination that the monitored distance crosses the first threshold, processor 106 may establish a second wireless communication with external device 108 via second wireless transceiver 104.

Further, processor 106 may monitor the distance between electronic device 100 and external device 108 via second wireless transceiver 104. In an example, when the monitored distance via first wireless transceiver 102 is less than the first threshold, processor 106 may establish the second wireless communication with external device 108 to monitor the distance. In another example, when the monitored distance via second wireless transceiver 104 is greater than or equal to the first threshold, processor 106 may establish the first wireless communication with external device 108 to monitor the distance.

In an example, processor 106 may utilize the first wireless communication or the second wireless communication to measure a signal strength or a time-of-flight (ToF) of a received signal. Further, processor 106 may estimate the distance between electronic device 100 and external device 108 based on the measured signal strength or the measured ToF. The first wireless communication may have a property different from the second wireless communication. An example property may include a distance detection range, a power consumption, a distance detection accuracy, or the like. For example, the first wireless communication may be a Bluetooth Low Energy (BLE) communication that measures a signal strength of a received signal to estimate the distance and the second wireless communication may be an Ultra-wideband (UWB) communication that measures a ToF of a received signal to estimate the distance.

Furthermore, processor 106 may control electronic device 100 to operate in a first power state or a second power state based on the monitored distance via first wireless transceiver 102 or second wireless transceiver 104. In an example, processor 106 may control electronic device 100 to operate in the first power state when the monitored distance is greater than or equal to the first threshold. Further, processor 106 may control electronic device 100 to operate in the second power state when the monitored distance is less than the first threshold. In this example, the second power state may have a power consumption different from the first power state.

In another example, processor 106 may determine whether the monitored distance via first wireless transceiver 102 or second wireless transceiver 104 is less than a second threshold. In this example, the second threshold is different from the first threshold. When the monitored distance is greater than or equal to the second threshold, processor 106 may control electronic device 100 to operate in the first power state. When the monitored distance is less than the second threshold, processor 106 may control electronic device 100 to operate in the second power state.

In other examples, processor 106 may detect a physical configuration mode of electronic device 100. An example physical configuration mode may be a clamshell-closed mode, a laptop mode, a tablet mode, a stand mode, or a tent mode. The term “clamshell-closed mode” may refer to a configuration in which a display screen is facing a keyboard and the two are parallel. The term “tent mode” may refer to a configuration in which the display screen is facing the user in landscape or inverted landscape orientation and is more than 180° open from the clamshell-closed state but may not be in the tablet (360°) mode. The term “tablet mode” may refer to a configuration in which the display screen is facing the user in a landscape, portrait, inverted landscape, or inverted portrait orientation. In the tablet mode, the keyboard is facing in the opposite direction from the display screen and the two are parallel. In the laptop mode, the display screen may be oriented at an angle, for example an obtuse angle, relative to a base housing to allow the user to view the display panel and to allow access to the keyboard of the base housing. The term “stand mode” may refer to a configuration in which the display screen is facing the user in landscape mode, with the keyboard sitting flat on the table. In the stand mode, the display screen is articulated between 270 and 360 degrees versus the keyboard.

Further, processor 106 may control electronic device 100 to operate in the first power state or the second power state based on a combination of the physical configuration mode and the determination whether the monitored distance crosses the first threshold. For example, when the monitored distance is less than the first threshold and when electronic device 100 is in the clamshell-closed mode, then processor 106 may enable electronic device 100 to connect to the internet, start to download emails, and keep the Internet-based functions ready (e.g., a skype call).

When the monitored distance is less than the first threshold and when electronic device 100 is in the laptop mode, then processor 106 may unlock the operating system and turn-on the display panel in addition to enabling electronic device 100 to connect to the Internet, start to download emails, and keep the internet-based functions ready (e.g., a skype call).

FIG. 2 is a block diagram of an example electronic device 200, depicting a processor 206 to return electronic device 200 to a working state from a power saving mode based on a user proximity to electronic device 200. As shown in FIG. 2, electronic device 200 may include a wireless transceiver 202, a sensor 204, and processor 206 connected to wireless transceiver 202 and sensor 204.

During operation, processor 206 may establish a wireless communication with an external device 208 via wireless transceiver 202. Further, processor 206 may monitor a distance between electronic device 200 and external device 208 via the wireless communication. In an example, electronic device 200 may be operating in a power saving mode.

Furthermore, processor 206 may detect whether the monitored distance via wireless transceiver 202 is less than a threshold. In an example, wireless transceiver 202 may utilize the BLE technology to estimate the distance via received signal strength (RSS) measurements and distance-based path-loss modelling. In the example BLE technology, processor 206 may transmit a BLE beacon to external device 208 using iBeacon and a BLE RSS may be used to derive the distance between electronic device 200 and external device 208.

In another example, wireless transceiver 202 may utilize a UWB technology to estimate the distance via time-of-arrival (TOA). In an example, The UWB technology may be used to estimate the distance based on knowing an exact time that a signal was sent from external device 208 (tₛₑₙₜ), an exact time the signal arrives at wireless transceiver 202 (tₐᵣᵣᵢᵥₐₗ), and the speed at which the signal travels (e.g., the speed of light (c)). In this example, the distance from external device 208 can be calculated using an equation:

$$d = c * ( {t}_{arrival} - {t}_{sent} ) .$$

In other examples, processor 206 may utilize the wireless communication to measure a time-of-flight (ToF) of a signal transmitted and received back by wireless transceiver 202 or measure an angle-of-arrival (AoA) of a signal received by wireless transceiver 202. Further, processor 206 may track a location of external device 208 to monitor the distance based on the measured ToF or the measured AoA.

In response to a determination that the monitored distance is less than the threshold, processor 206 may activate sensor 204 to determine whether a user is present at electronic device 200. For example, sensor 204 may include a ToF camera to sense the distance of the user from a display panel of electronic device 200. An example ToF camera may be a “depth camera”. The term “ToF camera” may refer to a sensor that can emit light in the infrared spectrum and then record the speed of the reflected light from a target object (e.g., the user). Based on a time difference between the emission of the light and its return to the ToF camera after being reflected by the target object, processor 206 may measure the distance between the target object and the ToF camera.

In other examples, sensor 204 may include a lower power state and a higher power state, and the sensor checks for presence of the user more frequently in the higher power state than in the lower power state. In this example, the lower power state or the higher power state may be activated based on the monitored distance via wireless transceiver 202. In some examples, processor 206 may detect a physical configuration mode of electronic device 200. Further, processor 206 may activate sensor 204 to determine whether the user is present at electronic device 200 based on a combination of the physical configuration mode and the determination that the monitored distance is less than the threshold.

Further, processor 206 may return electronic device 200 to a working state from the power saving mode in response to a determination that the user is present at electronic device 200. For example, in response to the determination that the user is present at electronic device 200, processor 206 may return electronic device 200 to the working state via unlocking an operating system of electronic device 200, turning-on a display panel of electronic device 200, or a combination thereof.

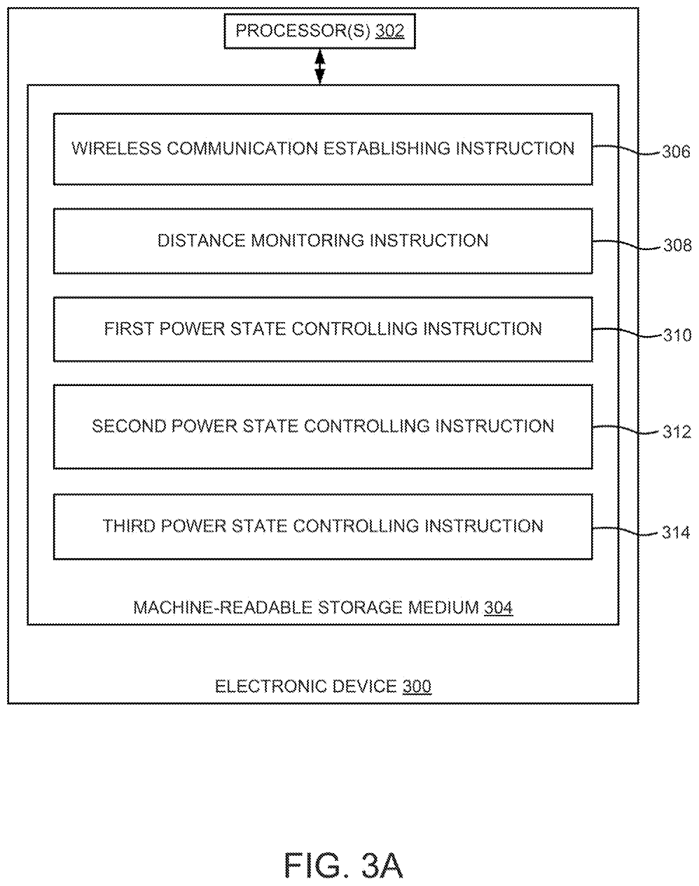

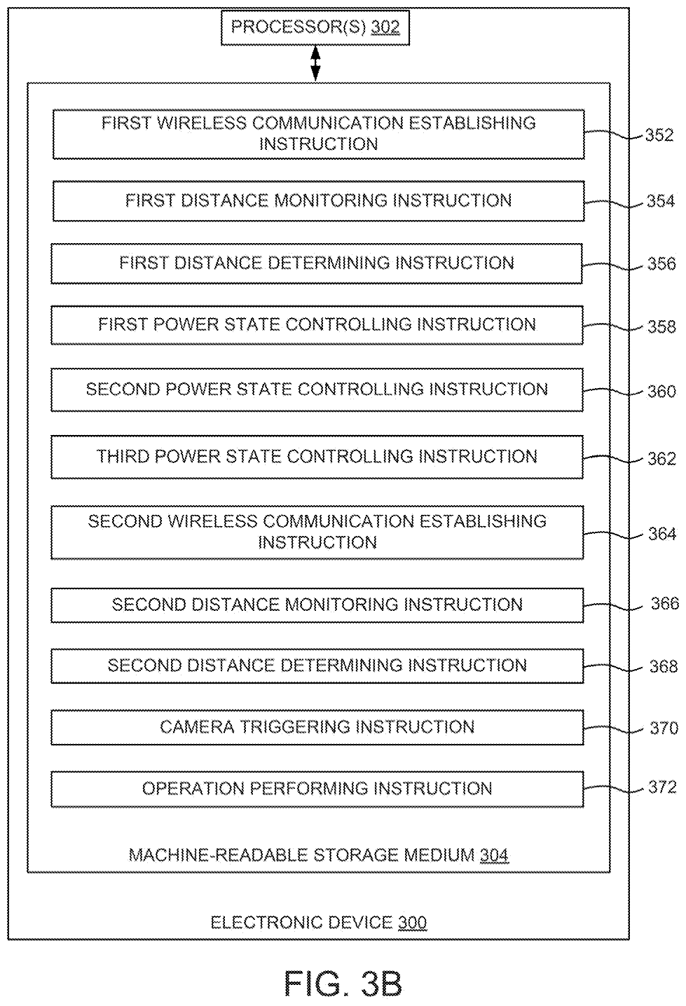

FIG. 3A is a block diagram of an example electronic device 300 including a non-transitory machine-readable storage medium 304, storing instructions to control electronic device 300 to operate in a power state based on a user proximity to electronic device 300. Electronic device 300 may include a processor 302 and machine-readable storage medium 304 communicatively coupled through a system bus. Processor 302 may be any type of central processing unit (CPU), microprocessor, or processing logic that interprets and executes machine-readable instructions stored in machine-readable storage medium 304.

Machine-readable storage medium 304 may be a random-access memory (RAM) or another type of dynamic storage device that may store information and machine-readable instructions that may be executed by processor 302. For example, machine-readable storage medium 304 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 304 may be a non-transitory machine-readable medium. In an example, machine-readable storage medium 304 may be remote but accessible to electronic device 300.

As shown in FIG. 3A, machine-readable storage medium 304 may store instructions 306-314. In an example, instructions 306-314 may be executed by processor 302 to operate electronic device 300 in a particular power state based on the user proximity. Instruction 306 may be executed by processor 302 to establish a first wireless communication with an external device. Instruction 308 may be executed by processor 302 to monitor a distance between electronic device 300 and the external device via the first wireless communication.

Instruction 310 may be executed by processor 302 to control electronic device 300 to operate in a first power state when the monitored distance is greater than a first range. Instruction 312 may be executed by processor 302 to control electronic device 300 to operate in a second power state in which a power consumption is greater than the first power state when the monitored distance is within the first range. Instruction 314 may be executed by processor 302 to control electronic device 300 to operate in a third power state in which the power consumption is greater than the second power state when the monitored distance is less than the first range.

FIG. 3B is a block diagram of example electronic device 300 of FIG. 3A including non-transitory machine-readable storage medium 304, storing instructions to perform additional features. For example, similarly named elements of FIG. 3B may be similar in structure and/or function to elements described with respect to FIG. 3A.

As shown in FIG. 3B, machine-readable storage medium 304 may store instructions 352-372. Instruction 352 may be executed by processor 302 to establish a first wireless communication with an external device. Instruction 354 may be executed by processor 302 to monitor a distance between electronic device 300 and the external device via the first wireless communication.

Instruction 356 may be executed by processor 302 to determine whether the monitored distance via the first wireless communication is within a first range. When the monitored distance is greater than the first range, instruction 358 may be executed by processor 302 to control electronic device 300 to operate in a first power state. When the monitored distance is within the first range, instruction 360 may be executed by processor 302 to control electronic device 300 to operate in a second power state in which a power consumption is greater than the first power state. When the monitored distance is less than the first range, instruction 362 may be executed by processor 302 to control electronic device 300 to operate in a third power state in which the power consumption is greater than the second power state.

When the monitored distance is less than the first range, instruction 364 may be executed by processor 302 to establish a second wireless communication with the external device. The second wireless communication may have a property different from the first wireless communication. In the third power state, the second wireless communication may be enabled, and the first wireless communication may be disabled.

Instruction 366 may be executed by processor 302 to monitor the distance between electronic device 300 and the external device via the second wireless communication. In an example, the first wireless communication may be a BLE communication, and the second wireless communication may be a UWB communication.

Instruction 368 may be executed by processor 302 to determine whether the monitored distance via the second wireless communication is within a second range. The second range may be less than the first range. In an example, when the monitored distance via the second wireless communication is less than the first range and greater than the second range, the distance may be monitored via the second wireless communication while operating electronic device 300 in the third power state.

When the monitored distance via the second wireless communication is within the second range, instruction 370 may be executed by processor 302 to trigger a ToF camera to determine whether a user is present at electronic device 300. Instruction to trigger the ToF camera to determine whether the user is present at electronic device 300 may include instruction to:
detect whether a display panel of electronic device 300 is in an open position relative to a base of electronic device 300, and
trigger the ToF camera to determine the distance of the user from the display panel upon a determination that the display panel is in the open position.

Instruction 372 may be executed by processor 302 to perform an operation associated with electronic device 300 when the user is present at electronic device 300. For example, the operation associated with electronic device 300 may include return electronic device 300 to the working state from the third power state, unlock an operating system of electronic device 300, turn on the display panel of electronic device 300, or any combination thereof.

In other examples, when the monitored distance via the second wireless communication (e.g., the UWB communication) is greater than a lower limit of the first range, processor 302 may determine that the external device is away from electronic device 300 and activate the first wireless communication (e.g., the BLE communication) to determine whether the user is within a range of the first wireless communication. When the user is determined to be within the range of the first wireless communication, processor 302 may place electronic device 300 into the first power state or the second power state based on the monitored distance (e.g., as explained with respect to instructions 358 and 360).

In other examples, machine-readable storage medium 304 may store instructions to estimate a rate of change of the distance between electronic device 300 and the external device, and control electronic device 300 to operate in the first power state, second power state, or the third power state based on the monitored distance and the estimated rate of change. In some examples, discrete threshold ranges may not be sufficient to understand a true intent of the user. For example, when the user is in a range of the first wireless transceiver, but the monitored distance is determined to be static and not increasing or decreasing significantly, then the user may be determined to be static and no longer moving towards electronic device 300. For example, the user may be determined to be static as the user might be watching television in an adjacent room. In such scenarios, examples described herein may consider a “rate of change” parameter in combination with the absolute threshold ranges. The “rate of change” parameter may be defined as a delta of distance divided by a certain time period. The “rate of change” parameter may allow processor 302 to determine if the user is moving towards or away from electronic device 300 and use this data to accurately match up to the user's intent about waking towards or away from electronic device 300. For example, processor 302 may detect that the user is static and place electronic device 300 into a low power state. In another example, processor 302 may detect that the user is actively moving towards electronic device 300 and transition electronic device 300 into a higher power state from the low power state.

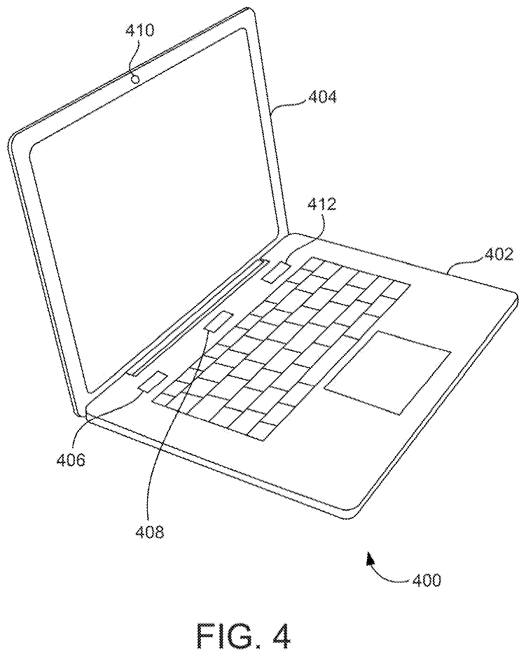

FIG. 4 is a schematic representation of an example electronic device 400, depicting a processor 412 to return electronic device 400 to a working state from a power saving mode. In the example shown in FIG. 4, electronic device 400 may be a laptop computer having a base housing 402 and a display housing 404 that may be rotatably, detachably, or twistably connected to base housing 402. For example, base housing 402 may house a keyboard, a battery, a touchpad, and so on. Display housing 404 may house a display panel (e.g., a touchscreen display panel). An example display panel may include a liquid crystal display (LCD), light emitting diode (LED), electro-luminescent (EL) display, or the like. In other examples, display housing 404 and base housing 402 may house other components such as a camera, audio/video devices, and the like, depending on the functions of electronic device 400.

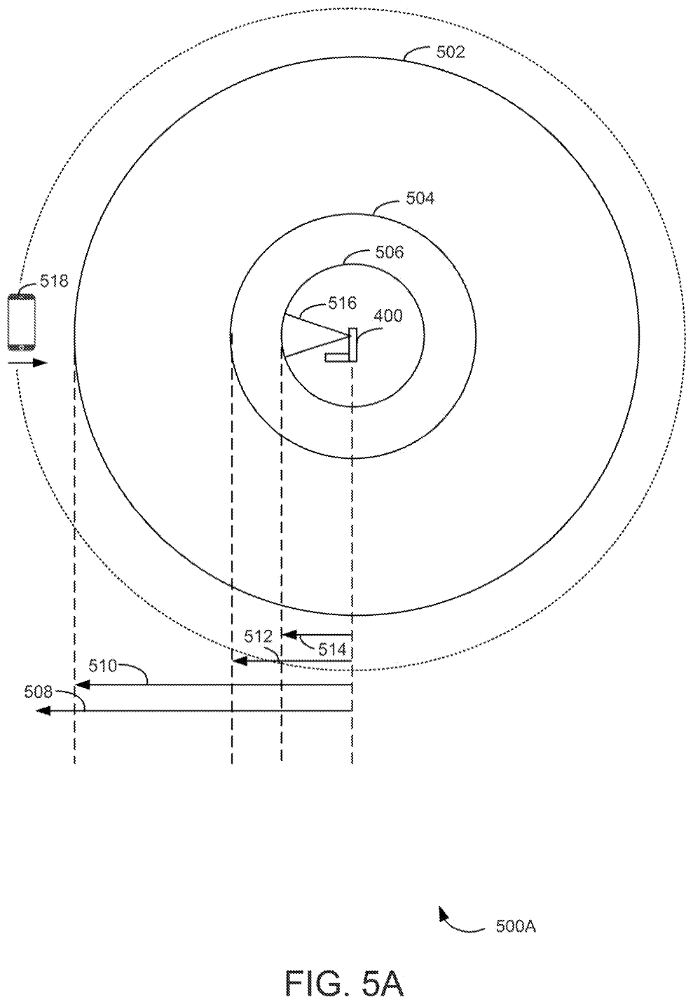

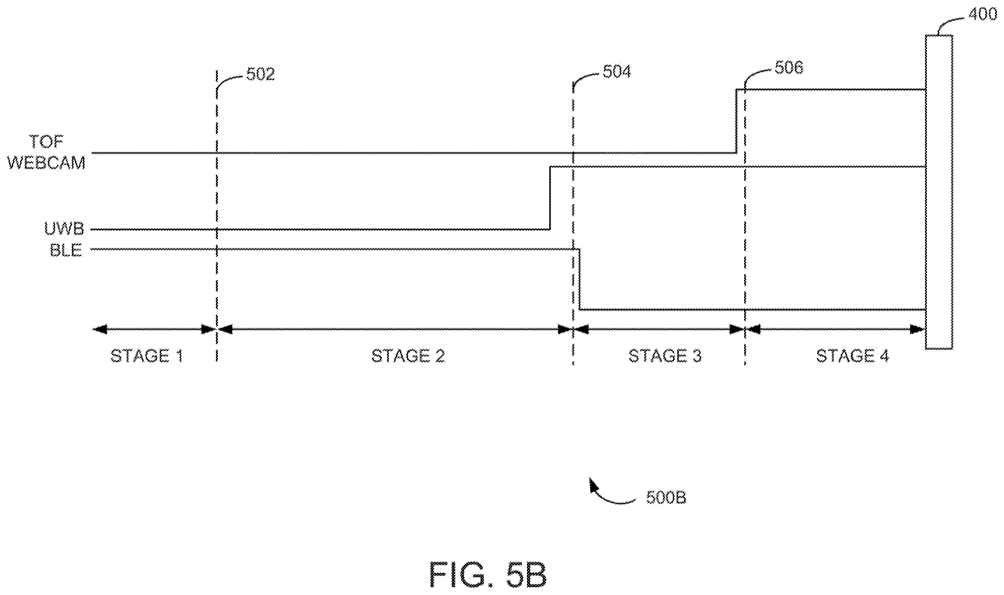

Further, electronic device 400 may include a first wireless transceiver 406, a second wireless transceiver 408, a ToF camera 410, and processor 412. In the example shown in FIG. 4, first wireless transceiver 406, second wireless transceiver 408, and processor 412 may be disposed in base housing 402 and ToF camera 410 may be disposed in display housing 404. In other examples, first wireless transceiver 406, second wireless transceiver 408, and processor 412 can be disposed in display housing 404. An example operation of first wireless transceiver 406, second wireless transceiver 408, ToF camera 410, and processor 412 is explained with respect to FIG. 5A.

FIG. 5A is a schematic diagram 500A, illustrating an example monitored distance and a corresponding operating condition of electronic device 400 of FIG. 4. As shown in FIG. 5A, processor 412 may establish a first wireless communication with an external device 518 of a user via first wireless transceiver 406. Further, processor 412 may monitor a distance between electronic device 400 and external device 518 via the first wireless communication. When the monitored distance is greater than a first threshold 502 (e.g., as shown by 508), processor 412 may operate electronic device 400 in a first power state. When the monitored distance is less than first threshold 502 (e.g., as shown by 510), processor 412 may transition electronic device 400 from the first power state to a second power state.

When the monitored distance is less than a second threshold 504 (e.g., as shown by 512) that is less than first threshold 502, processor 412 may:
transition electronic device 400 from the second power state to a third power state,
establish a second wireless communication with external device 518 via second wireless transceiver 408, and
monitor the distance between electronic device 400 and external device 518 via the second wireless communication.

When the monitored distance via the second wireless communication is less than a third threshold 506 (e.g., as shown by 514) that is less than second threshold 504, processor 412 may:
trigger ToF camera 410 to determine whether a user is present at electronic device 400 (e.g., within a field of view 516 of ToF camera 410), and
perform an operation (e.g., unlock an operating system, turn on a display panel, or the like) associated with electronic device 400 when the user is present at electronic device 400. An example operation to return electronic 400 device to a working state from a power saving mode using a BLE communication and a UWB communication is explained with respect to FIG. 5B.

FIG. 5B is a schematic diagram 500B, depicting an example operation to return electronic device 400 to the working state from the power saving mode based on the monitored distance. For example, similarly named elements of FIG. 5B may be similar in structure and/or function to elements described with respect to FIG. 5A. Consider that first wireless transceiver 406 (e.g., as shown in FIG. 4) may be a BLE transceiver and second wireless transceiver 408 (e.g., as shown in FIG. 4) may be a UWB transceiver.

In an example, electronic device 400 may be provided with the Bluetooth transceiver and the UWB transceiver to pair, connect, and/or communicate with the external device. As shown in FIG. 5B, the example operation to return electronic device 400 to a working state from a power saving mode may involve four stages and distance monitoring may be performed by connecting electronic device 400 and the external device (e.g., a mobile phone) through different wireless technologies.

When the monitored distance is greater than first threshold 502 (e.g., distance ≥45 meters), electronic device 400 may be operated in the first power state at stage 1. In an example first power state, electronic device 400 may be operated in a hibernated mode, however, the BLE transceiver may be connected to the external device to monitor the distance occasionally (e.g., at first time intervals).

When the monitored distance is between first threshold 502 (e.g., 45 meters) and second threshold 504 (e.g., 5 meters), electronic device 400 may be operated in the second power state at stage 2. In an example second power state, electronic device 400 may still be operated in the hibernated mode, however, electronic device 400 may wake up a function to monitor/update the distance frequently (e.g., at second time intervals) via the BLE transceiver.

When the monitored distance is between second threshold 504 (e.g., 5 meters) and third threshold 506 (e.g., 30 centimeters), electronic device 400 may be operated in the third power state at stage 3. In an example third power state, electronic device 400 may be switched to a modern standby mode from the hibernated mode. In an example modern standby mode, electronic device 400 may start to download emails and keep internet functions (e.g., a skype call) ready. Further, in the third stage, the distance monitoring may be transferred from the BLE transceiver to the UWB transceiver. For example, the UWB technology may have an accuracy greater than the BLE technology to monitor the user's range. For example, the accuracy of UWB technology may be up to 30 centimeters, while the accuracy of the BLE technology may be up to 1 meter. In the third stage, the BLE transceiver can be deactivated once the distance monitoring is transferred to the UWB transceiver.

When the monitored distance via the UWB transceiver is less than third threshold 506, a check may be made to determine whether a display panel of electronic device 400 is in an open position relative to a base of electronic device 400. When the display panel is in the open position, ToF camera 410 may be triggered to oversee the user's distance and range. When the user is present at electronic device 400, then processor 412 may unlock the OS and turn on the display panel. Thus, when the user sits in front of electronic device 400, processor 412 may return electronic device 400 to a working state, such that the user can start working seamlessly without inputting a password or waiting for email to be downloaded.

When the display panel is in the closed position, then electronic device 400 may continue to operate in the third power state (e.g., as explained with respect to stage 3). Thus, examples described herein may optimize user experience, power consumption, and achieve significantly faster resuming of electronic device 400 from the power saving mode to the working state. By detecting the user's position, electronic device 400 can optimize the power consumption, thereby enhancing the battery life. Examples described herein may also provide security since electronic device 400 is unlocked via a paired external device.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
a first wireless transceiver;
a second wireless transceiver; and
a processor connected to the first wireless transceiver and the second wireless transceiver, wherein the processor is to:
establish a first wireless communication with an external device via the first wireless transceiver;
monitor a distance between the electronic device and the external device via the first wireless transceiver;
in response to a determination that the monitored distance crosses a first threshold:
establish a second wireless communication with the external device via the second wireless transceiver; and
monitor the distance between the electronic device and the external device via the second wireless transceiver; and
control the electronic device to operate in a first power state or a second power state based on the monitored distance via the first wireless transceiver or the second wireless transceiver.

2. The electronic device of claim 1, wherein the processor is to:
control the electronic device to operate in the first power state when the monitored distance is greater than or equal to the first threshold; and
control the electronic device to operate in the second power state when the monitored distance is less than the first threshold, and wherein the second power state having a power consumption different from the first power state.

3. The electronic device of claim 1, wherein the processor is to:
determine whether the monitored distance via the first wireless transceiver or the second wireless transceiver is less than a second threshold, wherein the second threshold is different from the first threshold;
control the electronic device to operate in the first power state when the monitored distance is greater than or equal to the second threshold; and
control the electronic device to operate in the second power state when the monitored distance is less than the second threshold, and wherein the second power state having a power consumption different from the first power state.

4. The electronic device of claim 1, wherein the processor is to utilize the first wireless communication or the second wireless communication to:
measure a signal strength or a time-of-flight (ToF) of a received signal; and
estimate the distance between the electronic device and the external device based on the measured signal strength or the measured ToF.

5. The electronic device of claim 1, wherein the processor is to:
detect a physical configuration mode of the electronic device, wherein the physical configuration mode comprises a clamshell-closed mode, a laptop mode, a tablet mode, a stand mode, or a tent mode; and
control the electronic device to operate in the first power state or the second power state based on a combination of the physical configuration mode and the determination whether the monitored distance crosses the first threshold.

6. An electronic device comprising:
a wireless transceiver;
a sensor; and
a processor connected to the wireless transceiver and the sensor, wherein the processor is to:
establish a wireless communication with an external device via the wireless transceiver;
monitor a distance between the electronic device and the external device via the wireless communication, the electronic device operating in a power saving mode;
detect whether the monitored distance is less than a threshold via the wireless transceiver;
in response to a determination that the monitored distance is less than the threshold, activate the sensor to determine whether a user is present at the electronic device; and
return the electronic device to a working state from the power saving mode in response to a determination that the user is present at the electronic device.

7. The electronic device of claim 6, wherein the sensor comprises a time-of-flight (ToF) camera to sense a distance of the user from a display panel of the electronic device.

8. The electronic device of claim 6, wherein the processor is to:
detect a physical configuration mode of the electronic device, wherein the physical configuration mode comprises a clamshell-closed mode, a laptop mode, a tablet mode, a stand mode, or a tent mode; and
activate the sensor to determine whether the user is present at the electronic device based on a combination of the physical configuration mode and the determination that the monitored distance is less than the threshold.

9. The electronic device of claim 6, wherein in response to the determination that the user is present at the electronic device, the processor is to:
unlock an operating system of the electronic device;
turn-on a display panel of the electronic device; or
a combination thereof.

10. The electronic device of claim 6, wherein the processor is to utilize the wireless communication to:
measure a time-of-flight (ToF) of a signal transmitted and received back by the wireless transceiver; or
measure an angle-of-arrival (AoA) of a signal received by the wireless transceiver; and
track a location of the external device to monitor the distance based on the measured ToF or the measured AoA.

11. A non-transitory computer-readable storage medium encoded with instructions that, when executed by a processor of an electronic device, cause the processor to:
establish a first wireless communication with an external device;
monitor a distance between the electronic device and the external device via the first wireless communication;
when the monitored distance is greater than a first range, control the electronic device to operate in a first power state;
when the monitored distance is within the first range, control the electronic device to operate in a second power state in which a power consumption is greater than the first power state; and
when the monitored distance is less than the first range, control the electronic device to operate in a third power state in which the power consumption is greater than the second power state.

12. The non-transitory computer-readable storage medium of claim 11, further comprising instructions to:
when the monitored distance is less than the first range, establish a second wireless communication with the external device, the second wireless communication having a property different from the first wireless communication; and
monitor the distance between the electronic device and the external device via the second wireless communication.

13. The non-transitory computer-readable storage medium of claim 12, further comprising instructions to:
determine whether the monitored distance via the second wireless communication is within a second range, wherein the second range is less than the first range;
trigger a time-of-flight (ToF) camera to determine whether a user is present at the electronic device when the monitored distance via the second wireless communication is within the second range; and
perform an operation associated with the electronic device when the user is present at the electronic device, wherein the operation associated with the electronic device comprises return the electronic device to a working state from the third power state, unlock an operating system of the electronic device, turn on a display panel of the electronic device, or any combination thereof.

14. The non-transitory computer-readable storage medium of claim 11, further comprising instructions to:
estimate a rate of change of the distance between the electronic device and the external device; and
control the electronic device to operate in the first power state, second power state, or the third power state based on the monitored distance and the estimated rate of change.

15. The non-transitory computer-readable storage medium of claim 13, wherein instructions to trigger the ToF camera to determine whether the user is present at the electronic device comprise instructions to:
detect whether a display panel of the electronic device is in an open position relative to a base of the electronic device; and
trigger the ToF camera to determine the distance of the user from the display panel upon a determination that the display panel is in the open position.
